(19) United States
(12) Patent Application Publication
(10) Pub. No.: US 2015/0377526 A1
(43) Pub. Date: Dec. 31, 2015

(54) THERMOELECTRIC COOLER (TEC) CIRCUIT

(71) Applicant: Lumentum Operations LLC, Milpitas, CA (US)

(72) Inventors: Hock Gin LIM, San Jose, CA (US); Jimmy GO, Fremont, CA (US); Ricardo SAAD, Plano, TX (US); David L. WILSON, San Jose, CA (US); Chiachen CHANG, Saratoga, CA (US)

(21) Appl. No.: 14/316,986

(22) Filed: Jun. 27, 2014

(51) Int. Cl. F25B 21/04; G05D 23/19

(52) U.S. Cl. CPC F25B 21/04; G05D 23/1919

(57) ABSTRACT

A thermoelectric cooler (TEC) circuit is provided that includes a power supply, a TEC, and an H-bridge. The H-bridge, which is coupled to the power supply and ground, controls a direction of current through the TEC. The H-bridge comprises at least two low-resistance switches in integrated circuit (IC) form. The IC switches are each controlled by a digital control signal referenced to ground and each have an ON resistance of about 25 mΩ or less.

### TECHNICAL FIELD

The present invention relates to a thermoelectric cooler (TEC) circuit. More particularly, the present invention relates to a TEC circuit comprising an H-bridge including low-resistance switches.

### BACKGROUND

Thermoelectric coolers (TECs) are often used to stabilize the temperature of lasers and other temperature-sensitive devices. A TEC uses the Peltier effect to provide heating or cooling as a thermal output, depending on the direction of current through the TEC. The magnitude of current through the TEC determines the magnitude of the thermal output.

With reference to FIG. 1, a conventional TEC circuit 100 includes a TEC 110, a power supply 120, and an H-bridge 130. The H-bridge 130 includes four field-effect transistors (FETs) 131-134, e.g., metal-oxide-semiconductor field-effect transistors (MOSFETs). First and second FETs 131 and 132 are coupled to the power supply 120 and first and second terminals of the TEC 110, respectively. Third and fourth FETs 133 and 134 are coupled to the first and second terminals of the TEC 110, respectively, and ground.

The H-bridge 130 allows the unipolar power supply 120 to drive the bipolar TEC 110 in either direction for heating or cooling of a temperature-sensitive device. In other words, the H-bridge 130 controls the direction of current through the TEC 110, i.e., the voltage polarity of the TEC 110. The H-bridge 130 directs current through the TEC 110 in either a direction from the first terminal to the second terminal of the TEC 110 for heating or in an opposite direction for cooling. The four FETs 131-134 and, often, the power supply 120 are controlled by a control circuit (not shown in FIG. 1), e.g., a microcontroller and/or analog circuitry, in response to feedback from a sensing device (also not shown in FIG. 1), e.g., a thermistor or a TEC current or voltage monitor.

When driven in the heating direction, i.e., when Vh_tec>Vc_tec, the first and fourth FETs 131 and 134 are in an ON state, i.e., a conducting state, while the second and third FETs 132 and 133 are in an OFF state, i.e., a non-conducting state. Current flows from the power supply 120 to the TEC 110, via the first FET 131, to ground, via the fourth FET 134. The magnitude of current through the TEC 110 depends on the voltage across the TEC 110, i.e., Vh_tec−Vc_tec, and the resistive characteristics of the TEC 110. When driven in the cooling direction, i.e., when Vh_tec<Vc_tec, the second and third FETs 132 and 133 are in an ON state, while the first and fourth FETs 131 and 134 are in an OFF state. Current flows from the power supply 120 to the TEC 110, via the second FET 132, to ground, via the third FET 133.

With changes in temperature, it may be necessary to adjust the magnitude of current through the TEC 110 to any point within the operating current range of the TEC 110 and/or to change the direction of current through the TEC 110. Therefore, the TEC circuit 100 should operate smoothly with low to no current and should also minimize the amount of power dissipated at high current.

Unfortunately, the achievable efficiency of the TEC circuit 100 is limited by the drain-source ON resistance of the FETs 131-134. At high current through the TEC 110, it may not be possible to apply a large enough gate-source voltage to the FETs 131-134 to ensure that the FETs 131-134 are fully ON when in the ON state. For example, the source terminal of an active FET, e.g., 131, may be about 1-2 V above ground at high current through the TEC 110, limiting the gate-source voltage than can be applied to the FET, e.g., 131. When the FETs 131-134 are not fully ON, the drain-source ON resistance of the FETs 131-134 is undesirably high. Although FETs having lower drain-source ON resistance are known, they are, generally, too large for use in many optical modules, e.g., small form-factor pluggable (SFP) or enhanced small form-factor pluggable (SFP+) modules. Moreover, although in some embodiments, the FETs 131 and 132 may be driven by a pulse-width modulated signal at the largest possible gate-source voltage, this method often produces considerable noise and large ON/OFF currents and is, therefore, less desirable for many optical modules, e.g., SFP or SFP+ modules.

Examples of such a TEC circuit 100 are described in U.S. Pat. No. 7,024,864 to Alfrey, issued on Apr. 11, 2006, in U.S. Pat. No. 6,981,381 to Wang, et al., issued on Jan. 3, 2006, in U.S. Pat. No. 6,519,949 to Wernlund, et al., issued on Feb. 18, 2003, in U.S. Pat. No. 6,486,643 to Liu, issued on Nov. 26, 2002, in U.S. Pat. No. 6,205,790 to Denkin, et al., issued on Mar. 27, 2001, in U.S. Pat. No. 5,936,987 to Ohishi, et al., issued on Aug. 10, 1999, and in U.S. Patent Application Publication No. 2007/0163271 to Pan, et al., published on Jul. 19, 2007, all of which are incorporated herein by reference.

### SUMMARY

Accordingly, an aspect of the present invention relates to a thermoelectric cooler (TEC) circuit, comprising: a power supply; a TEC having first and second terminals; and an H-bridge for controlling a direction of current through the TEC, wherein the H-bridge is coupled to the power supply and ground, the H-bridge comprising: first and second integrated circuit (IC) switches coupled to the power supply and the first and second terminals of the TEC, respectively, wherein the first and second IC switches are each controlled by a digital control signal referenced to ground and each have an ON resistance of about 25 mΩ or less; and third and fourth switches coupled to the first and second terminals of the TEC, respectively, and ground.

In some embodiments, the third and fourth switches are IC switches that are each controlled by a digital control signal referenced to ground and that each have an ON resistance of about 25 mΩ or less. In other embodiments, the third and fourth switches are field-effect transistors (FETs) that are each controlled by an analog control signal.

### BRIEF DESCRIPTION OF THE DRAWINGS

Numerous exemplary embodiments will now be described in greater detail with reference to the accompanying drawings wherein:

FIG. 1 is a circuit diagram of a conventional thermoelectric cooler (TEC) circuit;

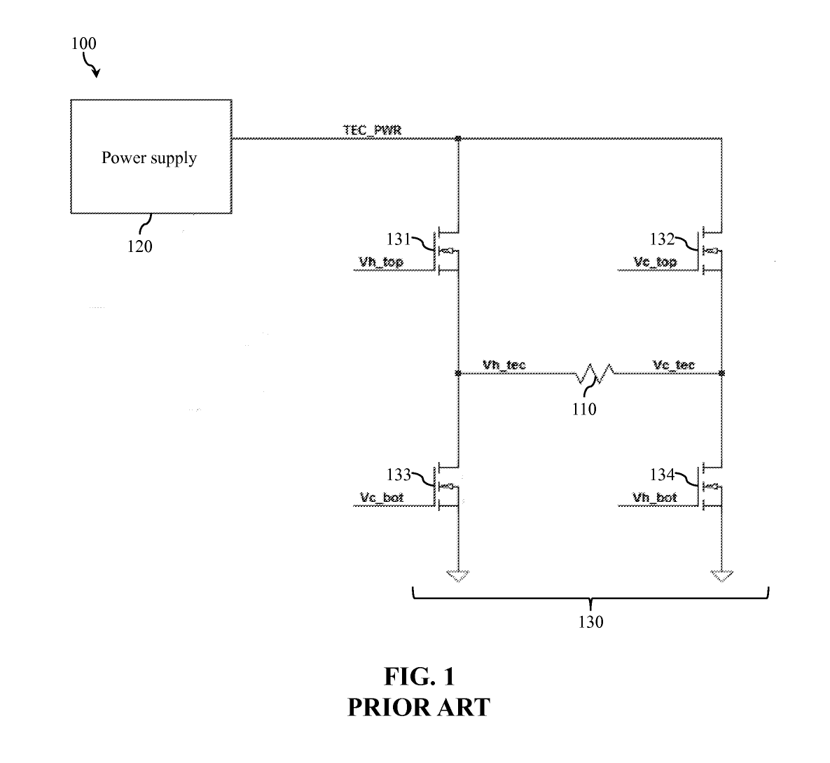

FIG. 2 is a circuit diagram of a first exemplary embodiment of a TEC circuit according to the present invention; and

FIG. 3 is a circuit diagram of a second exemplary embodiment of a TEC circuit according to the present invention.

### DETAILED DESCRIPTION

In an exemplary embodiment, the present invention provides a thermoelectric cooler (TEC) circuit having improved efficiency and smooth dynamic operation. The description that follows and the accompanying drawings focus on the specific details that are pertinent to the TEC circuit of the present invention, so as not to obscure the disclosure with details which will be readily apparent to those skilled in the art having the benefit of the description herein.

The TEC circuit of the present invention comprises an H-bridge including at least two low-resistance switches in integrated-circuit (IC) form. In some embodiments of the TEC circuit, the H-bridge includes four low-resistance IC switches, whereas in other embodiments of the TEC circuit, the H-bridge includes two low-resistance IC switches and two field-effect transistors (FETs), as explained in father detail hereafter.

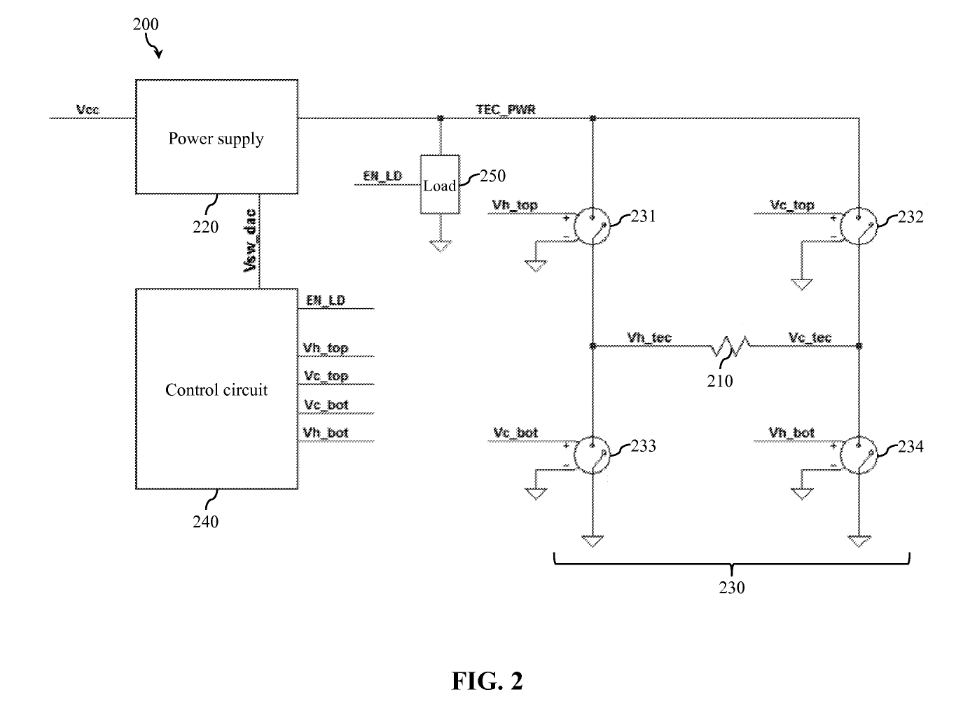

With reference to FIG. 2, a first exemplary embodiment of the TEC circuit 200 includes a TEC 210 having first and second terminals, a power supply 220, an H-bridge 230, a control circuit 240, and an optional load circuit 250. The H-bridge 230 includes four low-resistance switches 231-234 in IC form. First and second IC switches 231 and 232 are coupled to the power supply 220 and first and second terminals of the TEC 210, respectively. Third and fourth IC switches 233 and 234 are coupled to the first and second terminals of the TEC 210, respectively, and ground.

The TEC 210, which may be any suitable type of TEC, uses the Peltier effect to provide heating or cooling as a thermal output, depending on the direction of current through the TEC 210. The magnitude of current through the TEC 210 determines the magnitude of the thermal output. The thermal output provided by the TEC 210 is applied to a temperature-sensitive device, e.g., a laser, in order to stabilize its temperature. The thermal output is monitored by a sensing device (not shown in FIG. 2), e.g., a thermistor or a TEC current or voltage monitor.

The control circuit 240 controls the direction and magnitude of the current through the TEC 210 in response to feedback from the sensing device. Specifically, the control circuit 240 controls the power supply 220 and the four IC switches 231-234 of the H-bridge 230, as described in further detail hereafter. The control circuit may also control the optional load circuit 250. The control circuit 240 is, typically, operated in a proportional-integral-derivative (PID) loop.

The control circuit 240, typically, includes a microcontroller and a digital-to-analog (DAC) converter, which may be internal or external to the microcontroller. The microcontroller provides an analog control signal (Vsw_dac) to the power supply 220, via the DAC converter, and provides digital control signals (Vh_top, Vc_top, Vc_bot, and Vh_bot) to the four IC switches 231-234, via four general purpose input output (GPIO) pins. If desired, the number of GPIO pins used for the IC switches 231-234 may be reduced by the addition of combinatorial logic. When combinatorial logic is used, the IC switches 231-234 should have suitably fast turn-off times, and, in some instances, the power supply 220 may have to be turned off when changing from heating to cooling and vice versa, in response to an enable signal (not shown in FIG. 2) provided by the microcontroller. The microcontroller also provides a digital control signal (EN_LD) to the optional load circuit 250, when present, via an additional GPIO pin. Such a microcontroller-based design is particularly advantageous when used in a device, e.g., an optical module, already having a microcontroller. Alternatively, the control circuit 240 may be implemented as a logic circuit.

The power supply 220 provides power (TEC_PWR) to the TEC circuit 200. Typically, the power supply 220 is an adjustable power supply, such as a direct-current (DC) DC converter. The power supply 220 receives the system supply voltage (Vcc) and supplies a variable output voltage to control a magnitude of current through the TEC 210. The control circuit 240 provides a control signal (Vsw_dac), typically, as an analog voltage via a DAC, to adjust the magnitude of the output voltage of the power supply 220. Thereby, the magnitude of current through the TEC 210 is controlled. The output voltage is adjustable over an output voltage range of the power supply 220. In some instances, the power supply 220 has a minimum output voltage, typically, between about 0.1 V and about 1 V, e.g., 0.4 V or 0.6 V. The minimum output voltage may be the lowest output voltage allowing stable operation of the power supply 220 or may be the lowest output voltage providing a minimum efficiency, e.g., about 90%, that is acceptable or desirable for the power supply 220. In other instances, the power supply 220 is used to supply output voltages down to nearly 0 V, i.e., down to about 0.1 V or less.

In some instances, the TEC circuit 200 may include an optional load circuit 250, which may be activated by the control circuit 240 via a digital control signal (EN_LD), to provide additional stability when the power supply 220 requires a minimum load.

The H-bridge 230 allows the unipolar power supply 220 to drive the bipolar TEC 210 in either direction for heating or cooling of the temperature-sensitive device. In other words, the H-bridge 230 controls the direction of the current through the TEC 210, i.e., the voltage polarity of the TEC 210. The control circuit 240 activates one pair of IC switches, e.g., 231 and 234, and deactivates the other pair of IC switches, e.g., 232 and 233, via digital control signals. Accordingly, the H-bridge 230 directs current through the TEC 210 in either a direction from the first terminal to the second terminal of the TEC 210 for heating or in an opposite direction for cooling.

When driven in the heating direction, i.e., when Vh_tec>Vc_tec, the first and fourth IC switches 231 and 234 are in an ON state, i.e., a conducting state, while the second and third IC switches 232 and 233 are in an OFF state, i.e., a non-conducting state. Current flows from the power supply 220 to the TEC 210, via the first IC switch 231, to ground, via the fourth IC switch 234. The magnitude of current through the TEC 210 depends on the voltage across the TEC 210, i.e., Vh_tec−Vc_tec, and the resistive characteristics of the TEC 210. When driven in the cooling direction, i.e., when Vh_tec<Vc_tec, the second and third IC switches 232 and 233 are in an ON state, while the first and fourth IC switches 231 and 234 are in an OFF state. Current flows from the power supply 220 to the TEC 210, via the second IC switch 232, to ground, via the third IC switch 233.

In the first exemplary embodiment, all four IC switches 231-234 are low-resistance switches in IC form. Examples of suitable low-resistance switches in IC form include the Analog Devices ADP1196 switch, described in the Analog Devices ADP1196 Data Sheet, Revision B, April 2014, which is incorporated herein by reference, and the Micrel MIC94161/4 switches, described in the Micrel MIC94161/2/3/4/5 Data Sheet, Revision 1.0, Sep. 24, 2013, which is incorporated herein by reference.

The IC switches 231-234, typically, each include a FET, e.g., a metal-oxide-semiconductor field-effect transistor (MOSFET), and an internal micro boost converter, e.g., a charge pump. The micro boost converter, i.e., voltage up converter, serves to boost up the gate voltage of the FET internally, in order to achieve a low ON resistance. A discharge path is, typically, provided by electrostatic discharge structures (ESDs), e.g., Zener diodes. In some instances, the IC switches 231-234 may require an external voltage source. For example, if the digital logic of the IC switch 231-234 shares the voltage from the power supply 220, then the digital logic may not work when the power supply 220 falls below a certain voltage. In such instances, the external voltage serves to manage the internal digital logic independently from the primary voltage/current path. The IC switches 231-234 also, typically, each include at least four pins, a voltage input pin, a voltage output pin, a control input pin, and a ground pin.

The IC switches 231-234 are, generally, smaller than conventional low-resistance FETs. Typically, the IC switches 231-234 each have an area of about 3 mm² or less, preferably, of about 1.5 mm² or less, and a height of about 1.5 mm or less, preferably, of about 0.6 mm or less. In some instances, the IC switches 231-234 are packaged in a wafer-level chip-scale package (WLCSP).

Typically, the IC switches 231-234 each have an ON resistance of about 25 mΩ or less, preferably, of about 15 mΩ or less. Preferably, the ON resistance of the IC switches 231-234 is substantially constant over the operating current and voltage ranges of the TEC 210.

Typically, the IC switches 231-234 each have a turn-on time of about 10 ms or less, preferably, of about 5 ms or less, and a turn-off time of about 6 ms or less, preferably, of about 3 ms or less. Also typically, the turn-off time of each of the IC switches 231-234 is less than the turn-on time of that IC switch 231-234. This allows the same GPIO pin to control turn-off and turn-on of the IC switch 231-234 and ensures that the H-bridge 230 is fully opened before turning on the other half of the H-bridge 230. In particular, a fast turn-off time is necessary to prevent the H-bridge 230 from shorting to ground when the H-bridge 230 switches the voltage polarity of the TEC 210 from heating to cooling or vice versa. Firmware also ensures that switching the voltage polarity of the TEC 210 does not cause a short circuit.

The IC switches 231-234 are each controlled by a digital control signal referenced to ground, typically, a transistor-transistor logic (TTL) signal. Whereas the FETs used in conventional TEC circuits are controlled via a gate pin with an analog transfer characteristics, the IC switches 231-234 are controlled via a digital control pin referenced to ground via a ground pin. Advantageously, additional DACs or operational amplifiers for the IC switches 231-234 are not required in the control circuit 240, reducing the footprint of the TEC circuit 200. By using four IC switches 231-234, the first exemplary embodiment minimizes the number of components in the TEC circuit 200.

Unlike the FETs in conventional TEC circuits, the switches 231-234 are always either fully ON when in an ON state or fully OFF when in an OFF state. When the control circuit 240 provides a TTL HIGH level, e.g., 2 V, to the digital control pin of an IC switch, e.g., 231, the IC switch, e.g., 231, is fully ON, regardless of the TEC current or voltage and regardless of whether the IC switch, e.g., 231, is located at the top, i.e., between the power supply 220 and the TEC 210, or at the bottom, i.e., between the TEC 210 and ground, of the H-bridge 230.

In embodiments where the power supply 220 is used to supply output voltages down to nearly 0 V, the magnitude of current through the TEC 210 can be adjusted to any point within the operating current range of the TEC 210 by adjusting the output voltage of the power supply 220. In such embodiments, the power supply 220 is used to control the magnitude of current through the TEC 210, and the H-bridge 230 serves only to control the direction of current through the TEC 210.

In embodiments where the power supply 220 is used supply output voltages down to a minimum output voltage, the H-bridge 230 also serves to control the magnitude of current through the TEC 210 once the output voltage of the power supply 220 reaches the minimum output voltage. In such embodiments, the control circuit 240 includes a pulse-width modulator, typically, implemented in firmware and supporting logic, for pulse-width modulation (PWM). Once the minimum output voltage is reached, the control circuit 240 applies PWM control. Typically, the third and fourth IC switches 233 and 234, i.e., the bottom IC switches, are controlled by pulse-width modulated signals to adjust the magnitude of current through the TEC 210. Under PWM control, the control circuit 240 holds the power supply 220 at the minimum output voltage and drives the bottom IC switch, e.g., 234, of the activated pair of IC switches, e.g., 231 and 234, ON and OFF with an appropriate duty cycle to achieve a desired average magnitude of current through the TEC 210. Transitions to and from PWM control are controlled, typically, by firmware, to ensure temperature stability. Examples of methods of PWM control are disclosed in U.S. Pat. No. 6,519,949 to Wernlund, et al., issued on Feb. 18, 2003, in U.S. Pat. No. 6,486,643 to Liu, issued on Nov. 26, 2002, in U.S. Pat. No. 6,205,790 to Denkin, et al., issued on Mar. 27, 2001, and in U.S. Pat. No. 5,936,987 to Ohishi, et al., issued on Aug. 10, 1999.

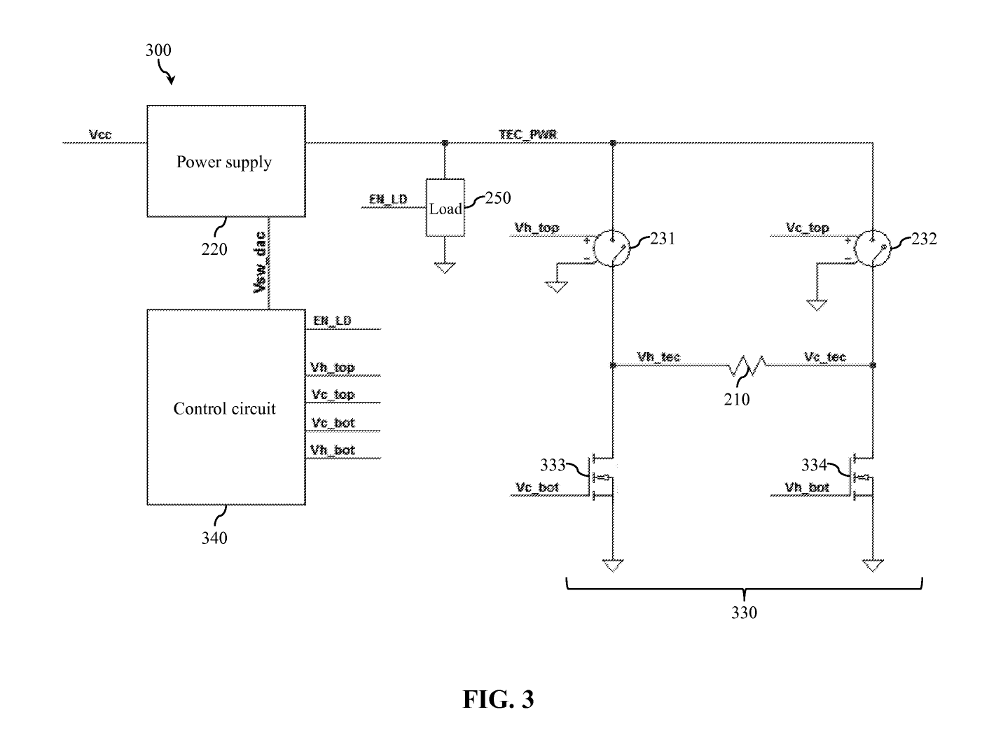

With reference to FIG. 3, a second exemplary embodiment of the TEC circuit 300 is similar to the first exemplary embodiment, but the H-bridge 330 includes two low-resistance switches 231 and 232 in IC form and two FETs 333 and 334, e.g., MOSFETs. Typically, the first and second IC switches 231 and 232 are located at the top of the H-bridge 330, and the third and fourth FETs 333 and 334 are located at the bottom of the H-bridge 330, as shown in FIG. 3. Alternatively, the two FETs could be located at the top of the H-bridge, and the two IC switches could be located at the bottom of the H-bridge, although this configuration is usually less desirable.

First and second IC switches 231 and 232 are coupled to the power supply 220 and first and second terminals of the TEC 210, respectively. Third and fourth FETs 333 and 334 are coupled to the first and second terminals of the TEC 210, respectively, and ground. The third and fourth FETs 333 and 334 are each controlled by analog voltages. Preferably, the third and fourth FETs 333 and 334 are n-channel MOSFETs with their source pins at ground, and the third and fourth FETs 333 and 334 can be driven at higher gate voltages without problems.

As in the first exemplary embodiment, the control circuit 340, typically, includes a microcontroller and a DAC, which may be internal or external to the microcontroller, for providing an analog control signal (Vsw_dac) to the power supply 220. In the second exemplary embodiment, the control circuit 340 also, typically, includes DACs, which may be internal or external to the microcontroller, for providing analog control signals (Vc_bot and Vh_bot) to the third and fourth FETs 333 and 334. Alternatively, the control circuit 340 may include a linear circuit using operational amplifiers to provide the analog control signals to the third and fourth FETs 333 and 334.

In the second exemplary embodiment, the power supply 220 is, typically, used to supply output voltages down to a minimum output voltage in order to control the magnitude of current through the TEC 210. The H-bridge 330 serves to control the direction of the current through the TEC 210, as described heretofore, and also serves to control the magnitude of the current through the TEC 210 once the output voltage of the power supply 220 reaches the minimum output voltage. As in the first exemplary embodiment, the first and second IC switches 231 and 232 are driven to be fully ON when in an ON state. The third and fourth FETs 333 and 334 are also driven to be fully ON when the output voltage of the power supply 220 is above the minimum output voltage. Once the minimum output voltage is reached, the control circuit 340 controls the third and fourth FETs 333 and 334 linearly to adjust the magnitude of current through the TEC 210. The third and fourth FETs 333 and 334 are driven to be less than fully ON, i.e., they are operated in linear mode. Under linear control, the control circuit 340 holds the power supply 220 at the minimum output voltage. The FET, e.g., 334 of the activated pair of switches, e.g., 231 and 334, is driven with an appropriate gate voltage to achieve a desired magnitude of current through the TEC 210. In the second exemplary embodiment, at the point where the current through the TEC 210 makes a transition between heating and cooling modes or vice versa, i.e., when the current is approximately 0 A, the voltage across both terminals of the TEC 210 is, typically, held at the minimum output voltage (TEC_PWR). That is, when driven at small voltages/currents, neither of the TEC 210 terminals is connected to ground. Examples of methods of linear control are disclosed in U.S. Pat. No. 7,024,864 to Alfrey, issued on Apr. 11, 2006, in U.S. Pat. No. 6,981,381 to Wang, et al., issued on Jan. 3, 2006, and in U.S. Pat. No. 6,486,643 to Liu, issued on Nov. 26, 2002.

The linear control used in the second exemplary embodiment of the TEC circuit 300, generally, produces less noise and requires less processing power than the PWM control used in the first exemplary embodiment. Advantageously, the TEC circuit 300 allows the full supply voltage, e.g., 3.3 V, minus a small voltage drop, to be available at the TEC 210. The TEC circuit 300 also allows the third and fourth FETs 333 and 334 to be driven at the maximum gate-source voltage, so that they are fully ON when they are not being operated in linear mode. On the other hand, if the two FETs were located at the top of the H-bridge, a voltage boost would be required to keep the FETS fully ON.

Of course, numerous other embodiments may be envisaged without departing from the spirit and scope of the invention.

We claim:

1. A thermoelectric cooler (TEC) circuit, comprising:
a power supply;
a TEC having first and second terminals; and
an H-bridge for controlling a direction of current through the TEC, wherein the H-bridge is coupled to the power supply and ground, the H-bridge comprising: first and second integrated circuit (IC) switches coupled to the power supply and the first and second terminals of the TEC, respectively, wherein the first and second IC switches are each controlled by a digital control signal referenced to ground and each have an ON resistance of about 25 mΩ or less; and third and fourth switches coupled to the first and second terminals of the TEC, respectively, and ground.

2. The TEC circuit of claim 1, wherein the first and second IC switches each include a field-effect transistor (FET) and a micro boost converter.

3. The TEC circuit of claim 1, wherein the first and second IC switches each have an area of about 3 mm² or less and a height of about 1.5 mm or less.

4. The TEC circuit of claim 1, wherein the first and second IC switches each have an ON resistance of about 15 mΩ or less.

5. The TEC circuit of claim 1, wherein the first and second IC switches each have a turn-on time of about 10 ms or less and a turn-off time of about 6 ms or less.

6. The TEC circuit of claim 5, wherein the turn-off time of each of the first and second IC switches is less than the turn-on time of that IC switch.

7. The TEC circuit of claim 1, wherein the first and second IC switches are each controlled by a transistor-transistor logic (TTL) signal.

8. The TEC circuit of claim 1, further comprising a microcontroller for providing the digital control signals to the first and second IC switches to control the direction of current through the TEC.

9. The TEC circuit of claim 1, wherein the power supply is an adjustable power supply for supplying a variable output voltage to control a magnitude of current through the TEC.

10. The TEC circuit of claim 9, wherein the power supply is a direct current (DC)-DC converter.

11. The TEC circuit of claim 1, wherein the third and fourth switches are FETs that are each controlled by an analog control signal.

12. The TEC circuit of claim 11, wherein the H-bridge is also for controlling a magnitude of current through the TEC, and wherein the third and fourth FETs are each linearly controlled to adjust the magnitude of current through the TEC.

13. The TEC circuit of claim 12, wherein the power supply is an adjustable power supply for supplying output voltages down to a minimum output voltage to control the magnitude of current through the TEC, wherein the H-bridge is for controlling the magnitude of current through the TEC once the minimum output voltage has been reached, and wherein the third and fourth FETs are each linearly controlled to adjust the magnitude of current through the TEC once the minimum output voltage has been reached.

14. The TEC circuit of claim 1, wherein the third and fourth switches are IC switches that are each controlled by a digital control signal referenced to ground and that each have an ON resistance of about 25 mΩ or less.

15. The TEC circuit of claim 14, wherein the H-bridge is also for controlling a magnitude of current through the TEC, and wherein the third and fourth IC switches are each controlled by pulse-width modulated signals to adjust the magnitude of current through the TEC.

16. The TEC circuit of claim 15, wherein the power supply is an adjustable power supply for supplying output voltages down to a minimum output voltage to control the magnitude of current through the TEC, wherein the H-bridge is for controlling the magnitude of current through the TEC once the minimum output voltage has been reached, and wherein the third and fourth FETs are each controlled by pulse-width modulated signals to adjust the magnitude of current through the TEC once the minimum output voltage has been reached.
